(19) United States
(12) Patent Application Publication
(10) Pub. No.: US 2009/0272797 A1
(43) Pub. Date: Nov. 5, 2009

(54) DYNAMIC INFORMATION CARD RENDERING

(75) Inventors: Thomas E. Doman, Pleasant Grove, UT (US); Duane F. Buss, West Mountain, UT (US); James G. Sermersheim, Woodland Hills, UT (US); Daniel S. Sanders, Orem, UT (US); Andrew A. Hodgkinson, Pleasant Grove, UT (US)

Correspondence Address: MARGER JOHNSON & MCCOLLOM, P.C. - NOVELL, 210 SW MORRISON STREET, SUITE 400, PORTLAND, OR, 97204, US

(73) Assignee: NOVELL, INC. A DELAWARE CORPORATION, Provo, UT (US)

(21) Appl. No.: 12/112,772

(22) Filed: Apr. 30, 2008

(51) Int. Cl. G06K 5/00

(52) U.S. Cl. 235/380

(57) ABSTRACT

A system and method for dynamic rendering of information cards is provided. A card selector uses policies and rendering content to modify the presentation of information cards in the card selector. The policies and rendering content can be obtained from identity providers and relying parties. The rendering content can be obtained each time the card selector is invoked, just prior to rendering the information cards, or at other times specified in the policy. The rendering content can be displayed in a display area of the information card or in a content canvas outside the display area of the information card.

### RELATED APPLICATION DATA

This application is related to co-pending U.S. application Ser. Nos. 11/843,572; 11/843,638; 11/843,640; 11/843,608 and 11/843,591, all of which were filed Aug. 22, 2007 and all of which claim the benefit of U.S. Application Ser. Nos. 60/895, 312; 60/895,316; 60/895,325, all of which were filed Mar. 16, 2007. This application is also related to U.S. application Ser. No. 12/019,104, filed Jan. 24, 2008, which claims the benefit of U.S. Application Ser. No. 60/973,679 filed Sep. 19, 2007. All of the foregoing applications are herein incorporated by reference.

### FIELD OF THE INVENTION

This invention pertains to information cards, and more particularly to modifying the presentation of information cards in a card selector using dynamic rendering.

### BACKGROUND OF THE INVENTION

When a user interacts with sites on the Internet (hereafter referred to as “service providers” or “relying parties”), the service provider often expects to know something about the user that is requesting the services of the provider. The typical approach for a service provider is to require the user to log into or authenticate to the service provider's computer system. But this approach, while satisfactory for the service provider, is less than ideal for the user. First, the user must remember a username and password for each service provider who expects such information. Given that different computer systems impose different requirements, and the possibility that another user might have chosen the same username, the user might be unable to use the same username/password combination on each such computer system. (There is also the related problem that if the user uses the same username/password combination on multiple computer systems, someone who hacks one such computer system would be able to access other such computer systems.) It is estimated that an average user has over 100 accounts on the Internet. For users, this is becoming an increasingly frustrating problem to deal with. Passwords and account names are too hard to remember. Second, the user has no control over how the service provider uses the information it stores. If the service provider uses the stored information in a way the user does not want, the user has relatively little ability to prevent such abuse, and essentially no recourse after the fact.

In the past year or two, the industry has developed the concept of information cards to attempt to address these problems. Information cards are a very familiar metaphor for users and the idea is gaining rapid momentum. Information cards allow users to manage their identity information and control how it is released. This gives users greater convenience in organizing their multiple personae, their preferences, and their relationships with vendors and identity providers. Interactions with on-line vendors are greatly simplified.

There are currently two kinds of information cards: 1) personal cards (or self-issued cards), and 2) managed cards—or cards that are issued by an identity provider. A personal card contains self-asserted identity information—the person issues the card and is the authority for the identity information it contains. The managed card is issued by an identity provider. The identity provider provides the identity information and asserts its validity.

When a user wants to release identity information to a relying party (for example, a web site that the user is interacting with), a tool known as a card selector assists the user in selecting an appropriate information card. When a managed card is selected, the card selector communicates with the identity provider to obtain a security token that contains the needed information. This interaction between the card selector and the identity provider is usually secure. The identity provider typically requests the user to authenticate himself or herself (for example, using a username/password, X.509 certificate, etc.) before it returns a security token. The identity information can then be provided to the relying party.

As part of the information card system the identity provider can create information cards which are then stored by the card selector. Thereby users can manage their digital identities from various identity providers, as well as selectively examine, manipulate and employ the identities with various online services. The information card is a representation of data that can be included in a security token, with associated claims issuer, authentication requirements, policies, and metadata.

According to the conventional information card system, the visual representation of an information card in the user's card selector is fixed at the time of issuance of the information card. As an example, metadata included with the issued card can be used to specify the visual representation of the card to look like a credit card. Once the card is issued and installed however, the visual representation of the card cannot be changed. Faced with this problem, the identity provider that issued the card would have to revoke the old card and issue a new card in order to simply change the visual representation of the card. Also, in the conventional information card system, the user does not have any way to manage the visual representations of the various cards in the card selector.

A need remains for a way to address these and other problems associated with the prior art.

### SUMMARY OF THE INVENTION

Embodiments of the invention enable dynamic rendering of information cards. A card selector enables the visual representation of information cards to change in response to policies defined by users, relying parties and/or identity providers. The card selector can use a policy and content provided by identity providers and/or relying parties to change the visual representations of information cards in the card selector.

The foregoing and other features, objects, and advantages of the invention will become more readily apparent from the following detailed description, which proceeds with reference to the accompanying drawings.

### BRIEF DESCRIPTION OF THE DRAWINGS

FIG. 1 shows a sequence of communications between a client, a relying party, and an identity provider.

FIG. 2 shows a system to perform dynamic rendering of information cards on a computer system, according to embodiments of the invention.

FIG. 3 shows the card selector of FIG. 2 providing dynamic rendering of information cards.

FIG. 4 shows a modifier used to modify the presentation of information cards in the system of FIG. 2.

FIG. 5 shows a remote content store according to some embodiments of the invention.

FIG. 6 shows a sequence of communications to obtain a managed card and dynamic rendering content according to an embodiment of the invention.

FIGS. 7A and 7B show a flowchart of a procedure to present an information card to a user according to an embodiment of the invention.

FIG. 8 shows details regarding obtaining content for dynamic rendering in the flowchart of FIGS. 7A and 7B.

### DETAILED DESCRIPTION OF THE PREFERRED EMBODIMENT

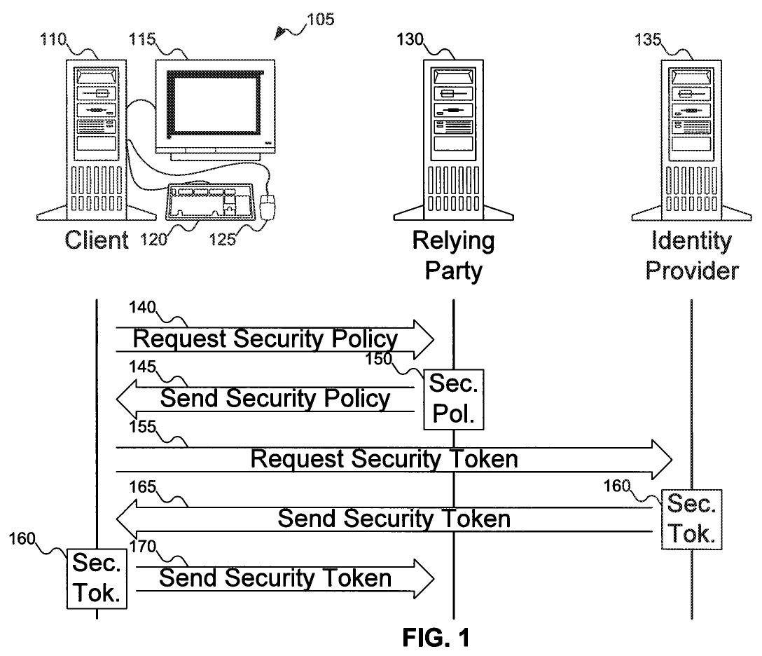

Embodiments of the invention include dynamic rendering of information cards. Consequently, before explaining the invention, it is important to understand the operation of an information card system. Such a system will be explained with respect to FIG. 1.

FIG. 1 shows a sequence of communications between a client, a relying party, and an identity provider. For simplicity, each party (the client, the relying party, and the identity provider) can be referred to by their machines. Actions attributed to each party are taken by that party's machine, except where the context indicates the actions are taken by the actual party.

In FIG. 1, computer system 105, the client, is shown as including computer 110, monitor 115, keyboard 120, and mouse 125. A person skilled in the art will recognize that other components can be included with computer system 105: for example, other input/output devices, such as a printer. In addition, FIG. 1 does not show some of the conventional internal components of client 105; for example, a central processing unit, memory, storage, etc. Although not shown in FIG. 1, a person skilled in the art will recognize that client 105 can interact with other computer systems, such as relying party 130 and identity provider 135, either directly or over a network (not shown) of any type. Finally, although FIG. 1 shows client 105 as a conventional desktop computer, a person skilled in the art will recognize that client 105 can be any type of machine or computing device capable of providing the services attributed herein to client 105, including, for example, a laptop computer, a personal digital assistant (PDA), or a cellular telephone.

Relying party 130 is a machine managed by a party that relies in some way on the identity of the user of client 105. The operator of relying party 130 can be any type of relying party. For example, the operator of relying party 130 can be a merchant running a business on a website. Alternatively, the operator of relying party 130 can be an entity that offers assistance on some matter to registered parties. Relying party 130 is so named because it relies on establishing some identifying information about the user.

Identity provider 135, on the other hand, is managed by a party responsible for providing identity information (or other such information) about the user for consumption by the relying party 130. Depending on the type of information identity provider 135 stores for a user, a single user might store identifying information with a number of different identity providers 135, any of which might be able to satisfy the request of the relying party 130. For example, identity provider 135 might be a governmental agency, responsible for storing information generated by the government, such as a driver's license number or a social security number. Alternatively, identity provider 135 might be a third party that is in the business of managing identity information on behalf of users.

The conventional methodology of releasing identity information can be found in a number of sources. One such source is Microsoft Corporation, which has published a document entitled Introducing Windows CardSpace, which can be found on the World Wide Web at http://msdn2.microsoft.com/en-us/library/aa480189.aspx and is hereby incorporated by reference. To summarize the operation of Windows CardSpace, when a user wants to access some data from relying party 130, client 105 requests the security policy of relying party 130, as shown in communication 140, which is returned in communication 145 as security policy 150. Security policy 150 is a summary of the information relying party 130 needs, how the information should be formatted, and so on.

Once client 105 has security policy 150, client 105 can identify which information cards satisfy security policy 150. Different security policies might result in different information cards being usable. For example, if relying party 130 simply needs an e-mail address, the information cards that can satisfy this security policy might be different from the information cards that can satisfy a security policy requesting the user's full name, mailing address, and social security number. The user can then select an information card that satisfies security policy 150.

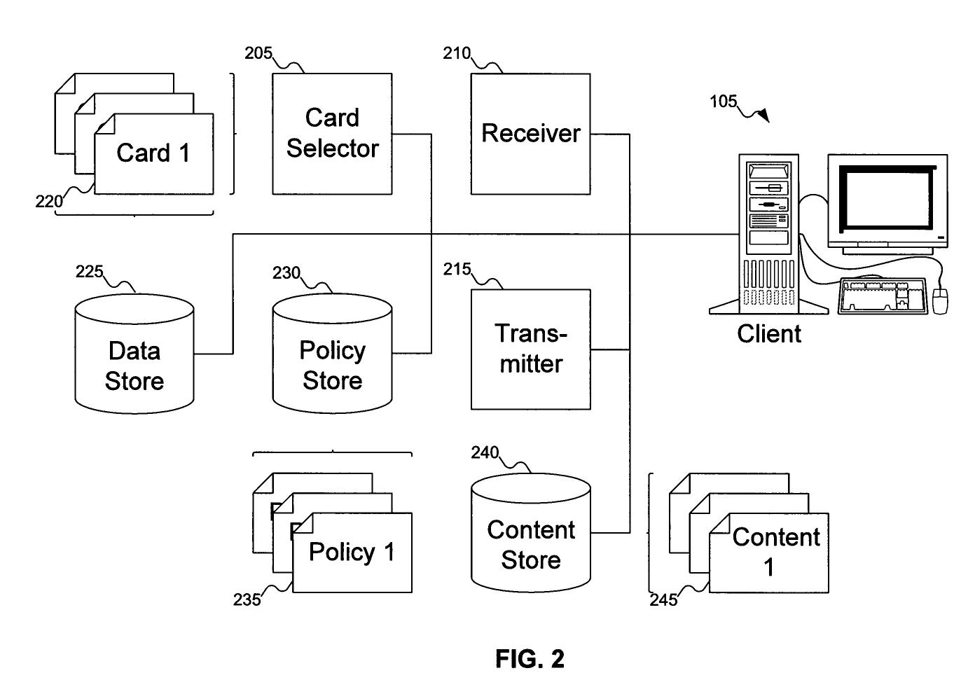

A card selector (described below with respect to FIG. 2) on client 105 can be used by the user to select the information card. The card selector can present the user with a list or graphical display of all available information cards and information cards that satisfy the security policy can be highlighted in some way to distinguish them from the remaining cards. Alternatively, the card selector can display only the information cards that can satisfy the security policy. The card selector can provide a means for the user to select the desired information card by, for instance, a mouse click or a touch on a touch screen.

Once the user has selected an acceptable information card, client 105 uses the selected information card to transmit a request for a security token from identity provider 135, as shown in communication 155. This request can identify the data to be included in the security token, the credential that identifies the user, and other data the identity provider needs to generate the security token. Identity provider 135 returns security token 160, as shown in communication 165. Security token 160 includes a number of claims, or pieces of information, that include the data the user wants to release to the relying party. Security token 160 can be encrypted in some manner, and perhaps signed and/or time-stamped by identity provider 135, so that relying party 130 can be certain that the security token originated with identity provider 135 (as opposed to being spoofed by someone intent on defrauding relying party 130). Client 105 then forwards security token 160 to relying party 130, as shown in communication 170.

In addition, the selected information card can be a self-issued information card (also called a personal card): that is, an information card issued not by an identity provider, but by client 105 itself. In that case, identity provider 135 effectively becomes part of client 105.

Often, the identity provider 135 takes the form of a web server, but this does not have to be the case. As an example, identity provider 135 could be a Security Token Service (STS) that resides on the client 105, resides on the network, or even resides on a flash drive.

According to the conventional information card system, the visual representation of an information card in the user's card selector is fixed at the time of issuance of the information card. As an example, metadata included with the issued card can be used to specify the visual representation of the card to look like a credit card. Once the card is issued and installed however, the visual representation of the card cannot be changed. Faced with this problem, the identity provider that issued the card would have to revoke the old card and issue a new card in order to simply change the visual representation of the card. Also, in the conventional information card system, the user does not have any way to manage the visual representations of the various cards in the card selector.

According to an embodiment of the invention, a card selector enables dynamic rendering of information cards so that the representation of the cards can be updated over time. It should be noted that the representation of the cards can include visual features and/or aural features.

FIG. 2 shows a system to perform dynamic rendering of information cards on computer system 105, according to embodiments of the invention. In FIG. 2, computer system 105 includes card selector 205, receiver 210, and transmitter 215. Card selector 205 enables a user to select information card 220 that satisfies the security policy. Receiver 210 receives data transmitted to computer system 105, and transmitter 215 transmits information from computer system 105.

A person skilled in the art will recognize that card selector 205 is simply one way to store data with which dynamic rendering can be used. For example, data store 225, which can be any type of data store, can be used to store data to allow dynamic rendering of other data types. If a different type of data store is used other than card selector 205, then information card 220 can be replaced with an appropriate type of data. For example, data store 225 can be, among other possibilities, an electronic wallet or a key ring, with information card 220 replaced with the appropriate data types for the information stored in data store 225. While the remainder of this document centers on the use of dynamic rendering with respect to information cards 220 in card selector 205, a person skilled in the art will recognize how embodiments of the invention can be modified to apply to other types of date stores.

Computer system 105 also includes policy store 230. Policy store 230 stores policies, such as policy 235, that describe how to apply dynamic rendering to the information cards in card selector 205 as well as when to obtain updates of dynamic rendering content. The policy 235 can be provided by a relying party, an identity provider, a user of computer system 105, and/or another entity (such as a network administrator). In the case of a user-defined policy, the user can set a policy for some or all of the information cards, so that content chosen by the user is associated with the information cards. In other words, the user can change the presentation of information cards in the card selector to meet the user's individual tastes.

Multiple policies can apply to a single information card and a single policy can apply to multiple information cards. Further, a policy can apply to a category of information cards. Categorization of information cards is described in U.S. patent application Ser. No. 11/843,591, titled “CREDENTIAL CATEGORIZATION”, filed Aug. 22, 2007, which is hereby incorporated by reference in its entirety. As an example, a single policy can apply to all information cards categorized as “credit cards.”

Finally, computer system 105 includes content store 240. Content store 240 stores dynamic rendering content, such as content 245, to be applied to the information cards. The dynamic rendering content in content store 240 is used by the policies in policy store 230 to control the application of dynamic rendering content to the information cards in card selector 205. For example, information card 220 can have an associated policy 235 that refers to content 245 for application to information card 220. Policy 235 can also indicate under what circumstances content 245 can be updated or replaced by new dynamic rendering content. Examples of content that can be stored in content store 240 can include a static image associated with the information card, an animation associated with the information card, a video clip associated with the information card, the source for the content, the expiration date of the content, and so on.

The content 245 can be obtained from a relying party, an identity provider, or any other source. As an example, a user can visit a website (i.e. an information card rendering content archive) and download various dynamic content that the user can associate with one or more information cards. Further, the user can define the content 245. Specifically, the user could associate images, animations, etc. with specific information cards and the associated images, animations, etc. can be stored in content store 240. For example, the user could associate a picture of the user with an information card representing driver's license data so that when the information card is presented in the card selector, it resembles a driver's license. The picture of the user can be stored as content 245 in content store 240.

Policy 235 can be stored in policy store 230 in a number of different ways. Policy 235 might include a default policy, provided when the user installs an information card. Also, policy 235 might be installed or updated after an information card is installed. Obtaining and updating policy 235 can be managed through cardflows. Cardflows are described in U.S. patent application Ser. No. 12/044,816, titled “SYSTEM AND METHOD FOR USING WORKFLOWS WITH INFORMATION CARDS”, filed Mar. 7, 2008, which is hereby incorporated by reference in its entirety. For example, a user might wish to have dynamic content from a particular relying party associated with a specific information card. The user can execute a cardflow to obtain or update the policy 235 associated with the specific information card. Then, when the policy is saved in policy store 230 and the specific information card is loaded into card selector 205, the policy can indicate what content from the content store 240 (or other source) is to be presented to the user.

Policy 235 can also indicate that content from multiple sources is to be combined in various ways. For example, policy 235 can specify that content from multiple sources can “phase”—that is, gradually change from one content to the next. Also, policy 235 can specify that the various content are to be assembled in a particular structure to present a unique appearance in card selector 205.

Although the various data stores of FIG. 2 are shown as discrete storage elements, a person skilled in the art will recognize that they can be combined. For example, a single data store can be responsible for storing all of the data: information card 220, policy 235, and content 245. Further, the various data elements can be stored in various formats, such as a database including a container hierarchy. Finally, while FIG. 2 shows the storage elements as being integral parts of computer system 105, a person skilled in the art will recognize that the storage elements can be stored anywhere that the data can be accessed from computer system 105: for example, on network attached storage or a USB flash drive, to provide two examples.

Card selector 205 enables dynamic rendering of information cards so that the representation of the cards can be updated over time. Card selector 205 allows various content to be associated with specific information cards stored in the card selector 205 and allows changes to such associations over time. Card selector 205 can change the “look and feel” of information cards stored in the card selector 205 in response to various events in the card selector and/or in the information card system.

The dynamic rendering content in content store 240 can be provided by many different sources. For example, the content can be provided with the card selector when the card selector is installed, the content can be downloaded from a network, and/or the content can be obtained from relying parties and identity providers, among other potential sources. Thus, the content is extensible and can be updated from various sources. The functions involved in obtaining content from the various sources can be handled by cardflows.

Various exemplary uses of dynamic rendering are described below. However, a person of ordinary skill in the art will recognize that the invention is not limited to these particular examples of dynamic rendering. Below are some examples of dynamic rendering of information cards:

A company has established a highly used, well trusted identity provider which has issued a large number of information cards to users. The cards are well known and the identity provider is an accepted issuer among many relying parties. In the card selectors of the users, the many issued information cards present the company's logo and have a company-established ‘look and feel’, just as they were issued. The company is then acquired by another company who wishes to have the information cards reflect the new ownership of the company. Under conventional methods, the new company would have to issue all new cards to replace the old cards in order to update the ‘look and feel’ of the cards. However, using dynamic rendering, the new company can publish an endpoint at the identity provider which can be used to provide a new representation of the cards. The change to the representation of the cards can serve to notify users of the change in ownership of the identity provider.

An owner of one or more identity providers wishes to communicate information to users of cards the identity providers have issued. For example, the information can include reputation information about relying parties. Relying party reputation information is described in U.S. patent application Ser. No. 12/042,205, titled “PRIVATELY SHARING REPLYING PARTY REPUTATION WITH INFORMATION CARD SELECTORS”, filed Mar. 4, 2008, which is hereby incorporated by reference in its entirety. The information can also include current state information for information cards. State information for information cards is described in U.S. patent application Ser. No. 12/029,373, titled “VISUAL AND NON-VISUAL CUES FOR CONVEYING STATE OF INFORMATION CARDS, ELECTRONIC WALLETS, AND KEYRINGS”, filed Feb. 11, 2008, which is hereby incorporated by reference in its entirety. In order to distribute this information, the owner can publish endpoints at the identity providers which can be used to provide content to the users. The content can provide the information in a form that is readily noticeable by users through dynamic rendering of the information cards.

An owner of one or more identity providers wishes to advertise other services which it provides, or which its partners can provide. The owner might wish to take advantage of its well-known and trusted status with relying parties that accept it as an issuer of information cards. For example, the owner could establish agreements with these relying parties whereby it would supply dynamic content to users of information cards it has issued as a service to the relying party for some fee. In order to distribute this dynamic content, the relying parties can publish endpoints at the identity providers which can be used to provide the content to the users. The content can provide the advertisements in a form that is readily noticeable by users through dynamic rendering of the information cards.

Depending on what information the owner has available and/or what agreements the owner has in place, the dynamic content can include: suggestions of other relying parties the user might wish to visit (i.e., partner sites or competitor sites); advertisements for relying parties with which the identity provider has agreements; advertisements for other services provided by the identity provider itself or partner services; user-specific messages; and general advertisements for consumer goods, network services, etc. Further, the dynamic content could be interactive. For example, the content could include hyperlinks and/or triggers through which additional content, services, or cardflows can be accessed or initiated.

A person of ordinary skill in the art will appreciate that because the content is being provided by endpoints at the identity provider, the card selector does not need to authenticate to any relying parties in order to receive the content. Instead, the card selector can receive the content based solely upon the relationship between the information cards it stores and the identity provider.

A user has a restricted use information card that is associated with a particular relying party or relying parties. Restricted use information cards are described in U.S. patent application Ser. No. 12/108,805, titled “RESTRICTED USE INFORMATION CARDS”, filed Apr. 24, 2008, which is hereby incorporated by reference in its entirety. The relying party, as part of the restricted use policy, can require the user to subscribe to dynamic content such as advertisements. The relying party can then publish an endpoint containing the dynamic content.

A relying party provides a certain type of information to visitors of its website (for example, a website devoted to video games). A user uses a personal information card to authenticate to the relying party. The user wants the presentation of the information card to reflect current information from the relying party, such as the latest video game releases. The relying party is willing to provide such information without the user authenticating to the relying party. Accordingly, the relying party publishes an endpoint that the user's card selector can query to obtain the latest presentation information. When the card selector displays the personal card, the content from the relying party can be used to define the presentation of the card.

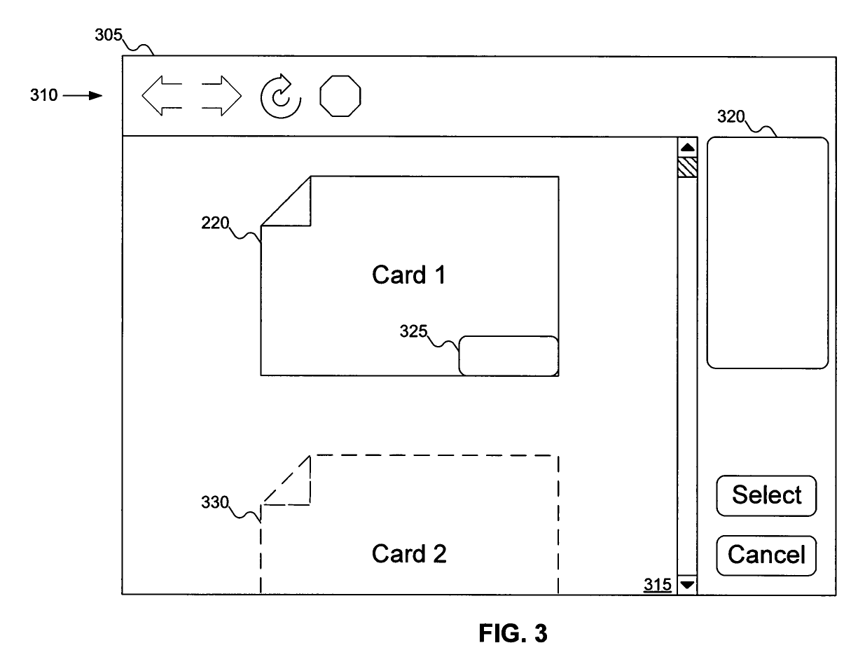

FIG. 3 shows the card selector of FIG. 2 providing dynamic rendering of information cards. In FIG. 3, screen 305 shows what card selector 205 might display to the user. Among other options, screen 305 can include navigation buttons 310, to permit the user to navigate around within card selector 205. Screen 305 can also include a main area 315, where information cards can be displayed to the user.

In main area 315, one whole information card 220 and a portion of a second information card 330 are shown. Visual content can be presented to the user in at least three different ways. First, a portion of the display area (or even the entire display area) of the information card 220 can be used as a canvas to display the visual content. Second, a hot spot 325 can be triggered by the user and expand to fill a portion or the entirety of the display area of the information card 220. The user can trigger the hot spot 325 by, among other things, clicking or touching in the hot spot or by hovering a pointer over the hot spot. Third, visual content can be rendered in the content canvas 320. In this case, even though the content is not rendered in the display area of the information card 220, the content is still associated with the information card 220.

While the above description is primarily focused on visual content, a person skilled in the art will recognize that a presentation can include content that is non-visual or both visual and some other form. For example, animations and movies can include aural aspects, such as sound, music, and speech. Also, the visual representation of information card 220 might not include any dynamic visual content, but it could be accompanied by aural content. For example, the aural content might include information about the associated identity provider, news stories, and/or advertisements. A person skilled in the art will recognize other possible aural content.

As discussed above with reference to FIG. 2, card selector 205 uses policies, such as policy 235, and content data, such as content 245, to determine the appropriate presentation to apply to a particular information card. Policy 235 defines how a particular information card is to be presented and the content is provided by content 245. Thus, for example, policy 235 can specify that when any information card issued by a particular identity provider is displayed, particular content can be applied to the information card to modify its presentation to the user.

Policy 235 can also define how and when new content is obtained for a particular information card. As further described below, the content to be applied to a specific information card does not have to be stored in content store 240 on computer system 105. The content can be obtained over a network at the time of the display of the information card or other times. Policy 235 can define how and when such content is obtained.

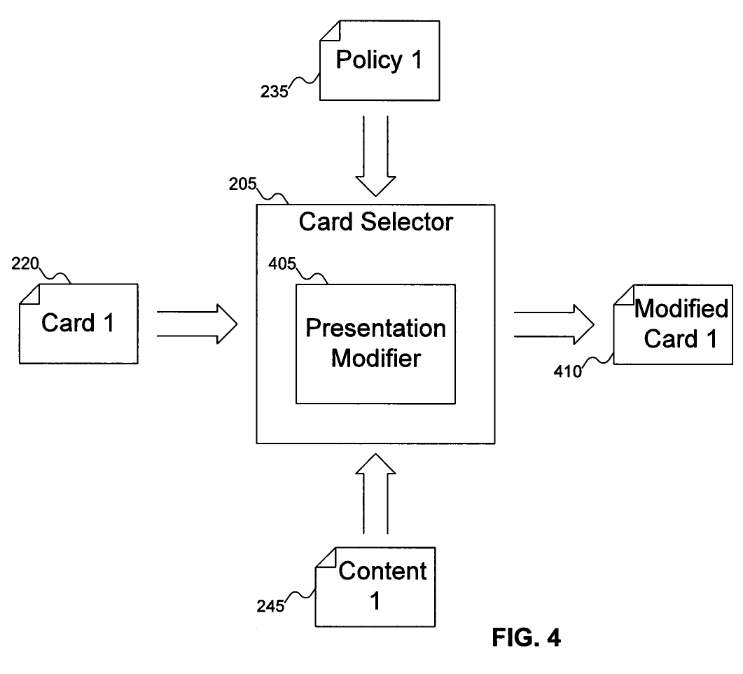

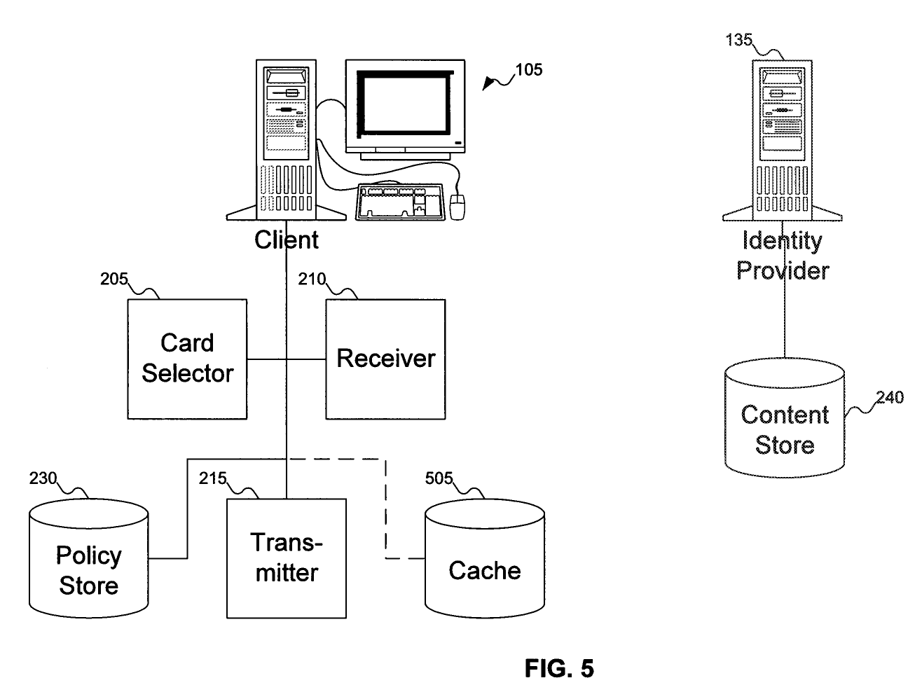

FIG. 4 shows a modifier used to modify the presentation of information cards in the system of FIG. 2. In FIG. 4, card selector 205 includes modifier 405. Modifier 405 modifies the presentation of the information card, to reflect the applicable policy 235 and the content 245. In FIG. 5, modifier 405 is shown applying a single policy to a single information card, but a person skilled in the art will recognize that modifier 405 can operate on all information cards, and can apply multiple policies to any individual information card or group of information cards.

In FIG. 4, it is assumed that policy 235 and content 245 are applicable to information card 220. This can be determined in any number of ways. For example, as each information card available to the user is identified, card selector 205 can determine whether any individual policy is applicable to the information cards. But a person skilled in the art will recognize that other implementations are possible. For example, modifier 405 can be responsible for identifying which policies and content are applicable to individual information cards, as well as the appropriate modification of the presentation of the information cards (in this situation, modifier 405 might directly access policy store 230 and content store 240, and so would not necessarily receive an individual policy or content to apply to an information card).

Modifier 405 takes policy 235 and content 245 and determines how the presentation of information card 220 should be modified. This modification presents to the user the content applicable to information card 220. For example, modifier 405 can modify the visual appearance of information card 220, if content 245 specifies visual content. Similarly, if content 245 specifies non-visual content, modifier 405 can modify the non-visual presentation of information card 405. The result produced by modifier 405 is modified card 410, which can then be presented to the user by card selector 205.

In the above described embodiments of the invention, it is assumed that all of the pertinent information for dynamic rendering (such as the information cards, the policies, and the content) is stored on computer system 105. But this is not always the case. For example, identity providers and relying parties might want to update content on a real-time basis. In such situations, the identity provider 135 and/or relying party 130 can store the content, as shown in FIG. 5 for the case of an identity provider. Computer system 105 still includes card selector 205, receiver 210, transmitter 215, and policy store 230, but identity provider 135 stores content store 240. Thus, the identity provider 135 can change the content on a real-time basis by updating the content in the content store 240.

In the system of FIG. 5, operation is basically the same as in the system of FIG. 2. But instead of locally accessing content store 240, computer system 105 requests the content from content store 240 on identity provider 135. Computer system 105 can request the content from identity provider 135 each time card selector 205 is invoked. But because a single user might have information cards managed by multiple identity providers, to make such a request and wait for the response from each identity provider, aside from potentially slowing down the operation of card selector 205, is tedious. However, such a process could be managed by a cardflow. Alternatively, the card selector 205 can request the content from the identity provider 135 just before rendering the card, so that content only needs to be obtained from identity providers for which a card may actually be rendered.

FIG. 5 shows policy store 230 on computer system 105 because policies, such as policy 235, might be applicable to multiple information cards, which could be managed by different identity providers. By storing policy store 230 on computer system 105, the policies can be applied by computer system 105 regardless of where the information cards are stored. But a person skilled in the art will recognize that policy store 230 can also be “outsourced” (that is, stored somewhere other than on computer system 105, although not necessarily on identity provider 135), to enable the use of the policies on multiple computer systems. In such a situation, computer system 105 can request copies of the policies and store them in a local cache, to be able to apply them to information cards as needed.

In another embodiment of the invention, policy store 230 is stored on the same system that stores content store 240, such as identity provider 135 in FIG. 5. Then, when card selector 205 requests content from identity provider 135, identity provider 135 can use the appropriate policy from policy store 230 to select the content to be used in presenting the information card and forward the appropriate content to computer system 105.

When the content store 240 is at the identity provider 135, it might be desirable to maintain cached copies of the content on the computer system 105 for short periods of time. For example, it might be desirable to have a cached copy of content 245 during a single user session in the event that one or more information cards need to be rendered several times. One way to accomplish this in the system of FIG. 5 is for computer system 105 to include cache 505. Cache 505 can store content for information cards of the user managed by various identity providers. This information can then be used to determine how to modify the presentation of information cards for the user. The issue then reduces to one of managing the update of cache 505. In such an embodiment, it is helpful for policy store 230 to be on computer system 105, or at least easily accessed by computer system 105, so that the appropriate content can be selected from cache 505 for presentation of an information card.

In one embodiment of the invention, computer system 105 requests content from each identity provider when the system connects to the network (or at some regular intervals thereafter: for example, once per day). Such a process can be managed by a cardflow. In another embodiment, each time computer system 105 requests a security token from identity provider 135, computer system 105 also requests a copy of the content in content store 240 (at least, the content applicable to information cards managed by identity provider 135 that belong to the user). The content in content store 240 can be obtained by, for example, computer system 105 querying an endpoint published at the identity provider 135. When querying the endpoint, the computer system 105 can supply information to the identity provider 135 such as: an identification of the specific information card for which content is sought; an identifier for the relying party being visited; and/or configuration information for the card selector 205. Computer system 105 then uses the content information received from the identity provider, however requested and whenever received, to update cache 505. A person skilled in the art will recognize other ways in which computer system 105 can update cache 505. A person skilled in the art will also recognize that these update policies mean that cache 505 can be out-of-date when card selector 205 accesses the content from cache 505. These concerns exist, but it is better to use accurate (if slightly out-of-date) information in the presentation of information cards than to not have the content at all.

As described above, computer system 105 requests content from identity provider 135. However, a person skilled in the art will recognize other ways in which computer system 105 can receive content from identity provider 135. For example, rather than waiting for a request from computer system 105, identity provider 135 can push information to computer system 105 when computer system 105 is reachable. In a push model, the machine with the information waits until the destination machine is known to be reachable, and then sends the information to the destination machine, without waiting for the destination machine to request the information. As another example, the card selector 205 could subscribe to a dynamic content feed. Obtaining content from a dynamic content feed can be based on a policy defined at both the card selector 205 and the identity provider 135. The card selector 205 can register for updates using a listener or other brokered connection. The identity provider 135 can use the dynamic content feed to deliver dynamic card rendering information, advertisements, event notices, and the like.

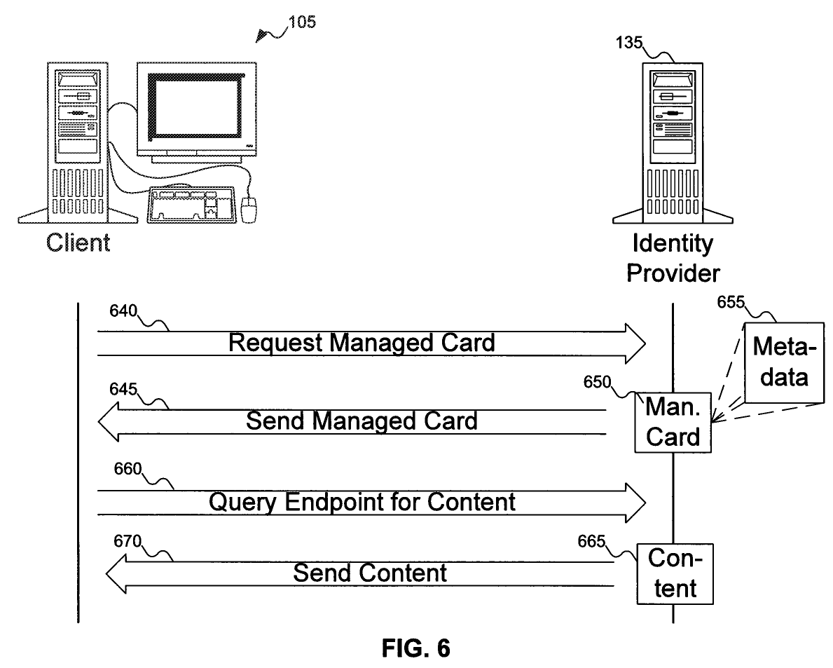

FIG. 6 shows a sequence of communications to obtain a managed card and dynamic rendering content according to an embodiment of the invention. When a user wants to obtain a managed card, the computer system 105 sends a request 640 for a managed card to the identity provider 135. The request 640 can be initiated by, for example, a user selecting a button on a form on a web page created by the identity provider 135. The request 640 can specify that the card selector 205 on computer system 105 supports dynamic rendering, although this is not required.

Once the identity provider 135 receives the request 640 for a managed card, the identity provider 135 examines the request and determines that the computer system 105 supports dynamic rendering. The identity provider 135 then generates the managed card 650. The managed card 650 can include metadata 655. Metadata 655 can include a policy for dynamic rendering of the information card and the metadata 655 can include content for dynamic rendering. The managed card 650 is then sent to the computer system 105 in communication 645.

Although in this example, the identity provider 135 determines whether the computer system 105 supports dynamic rendering, this does not have to be the case. For example, the identity provider 135 can automatically include dynamic rendering metadata with the managed card 650, without first determining whether the computer system 105 supports dynamic rendering. If the computer system 105 does not support dynamic rendering, then the computer system 105 can ignore the metadata 655.

When the computer system 105 receives the message 645 including the managed card 650, the computer system 105 invokes the card selector 205 in order to install the managed card 650. The computer system 105 can store the policy included in metadata 655 in the policy store 230. The computer system 105 can also store the content included in metadata 655 in the content store 240. Once the managed card 650 is installed, the card selector 205 can use the policy and the content received from the identity provider 135 to control the ‘look and feel’ of the card each time the card is presented to the user.

Although, as described above, the policy and content are provided with the information card, a person skilled in the art will recognize that such information does not need to be included with the card. For example, the card can be issued without any dynamic rendering information. In this case, the card selector 205 can query an endpoint at the identity provider 135 or elsewhere to obtain the policy and/or the content after the card is installed, as shown in communication 660. The content 665 can then be returned by the identity provider, as shown in communication 670. Obtaining dynamic rendering information after an information card is installed can be controlled by a cardflow.

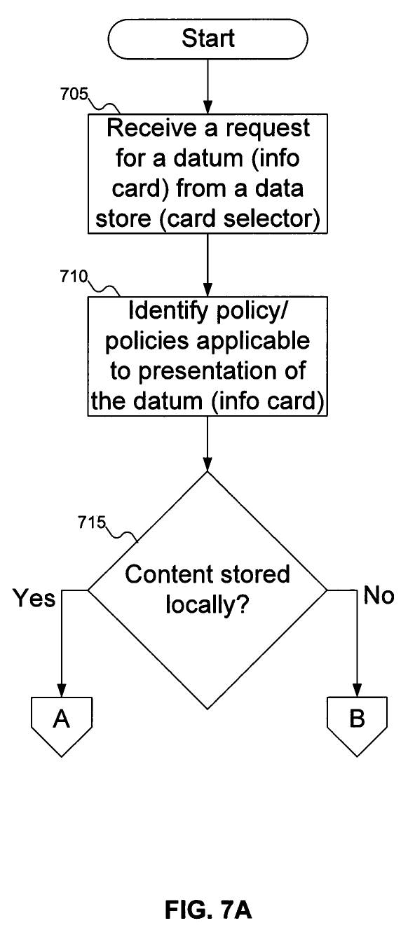

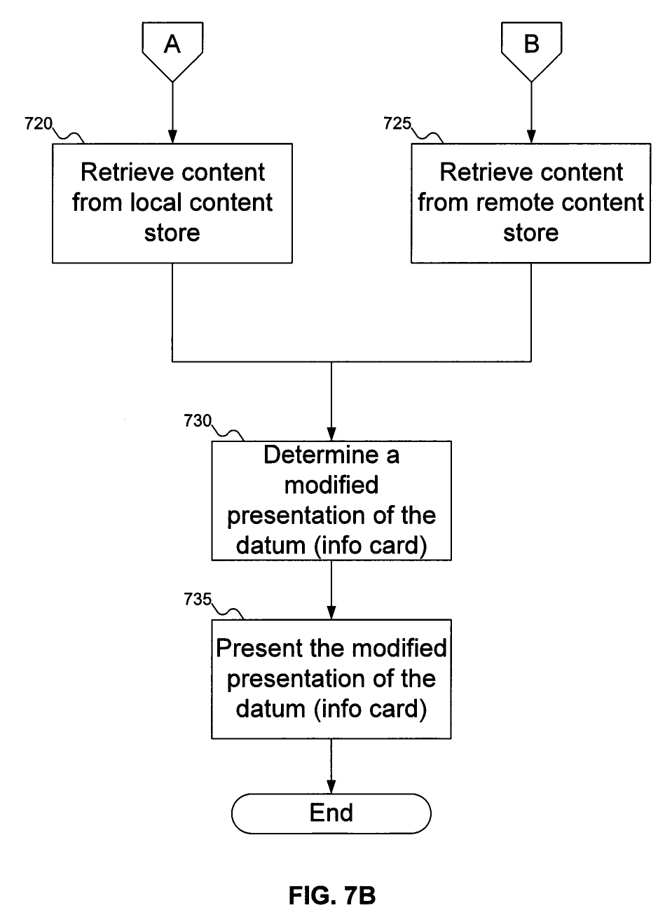

FIGS. 7A and 7B show a flowchart of a procedure to present an information card to a user according to an embodiment of the invention. Referring to FIGS. 7A and 7B, at block 705, a system receives a request for a datum from a data store. As discussed above, in one embodiment, this data store is a card selector, and the datum being requested is an information card. At block 710, the system determines policies that are applicable to the information card. At block 715, the system determines if appropriate content applicable to the information card is stored locally. If the appropriate content is stored locally, at block 720, the card selector retrieves the content from the local store, for example content store 240 or cache 505. If the appropriate content is not stored locally, at block 725, the card selector retrieves the content from a remote content store (i.e. an identity provider or a relying party). When the remote content store is at an identity provider or relying party, the card selector can retrieve the content by querying an endpoint published at the identity provider or relying party. At block 730, given the combination of the policy and the content, the system determines a modified presentation of the information card. As discussed above, this modified presentation can affect visual, aural, and other aspects of the presentation of the information card. Finally, at block 735, the system presents the modified information card to the user, providing the user with the appropriate content associated with the information card.

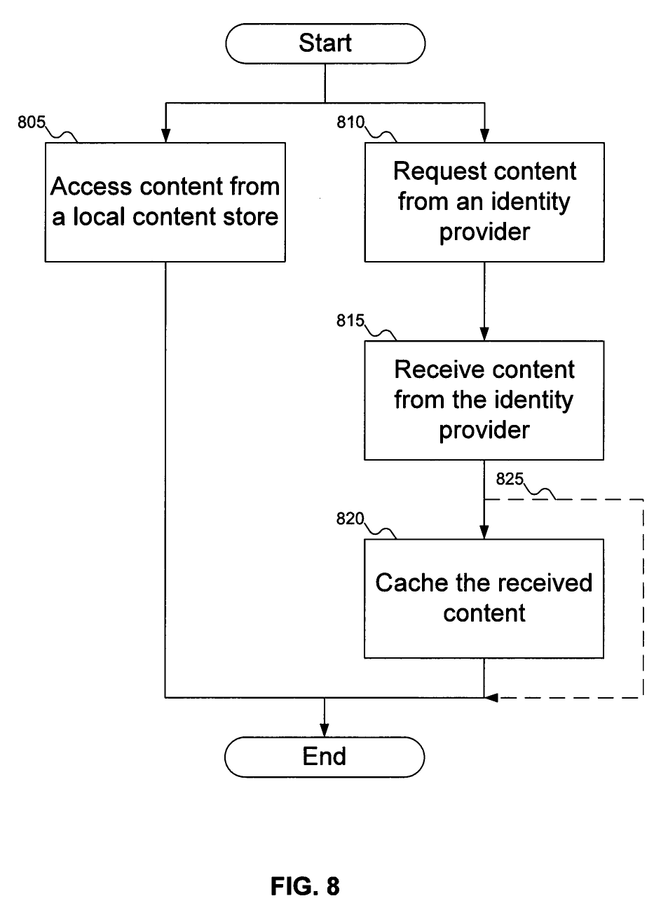

FIG. 8 shows details regarding obtaining content for dynamic rendering in the flowchart of FIGS. 7A and 7B. In FIG. 8, at block 805, the system accesses content from a content store that is local to the system. In the system of FIG. 2, this could be content store 240; in the system of FIG. 6, this could be cache 505. Alternatively, at block 810, the system can request content from an identity provider or relying party, among other possibilities. At block 815, the system can receive the content, which can then be used as described in block 730 of FIG. 7B. Finally, at block 820, the system can cache the content for later use. Block 820 is optional, as shown by dashed arrow 825.

As discussed previously, while the above description is in the context of a client using dynamic rendering in a card selector, a person skilled in the art will recognize how embodiments of the invention could be used with other data stores, such as electronic wallets and keyrings. Further, embodiments of the invention can be used in contexts other than transactions with relying parties. More particularly, any time a card selector is invoked, the card selector can use rendering content to affect the presentation of the information cards in the card selector. As it is possible for applications other than a web browser visiting a relying party's web site to activate the card selector, the card selector can perform dynamic rendering of information cards whenever invoked, by whatever application.

The following discussion is intended to provide a brief, general description of a suitable machine in which certain aspects of the invention can be implemented. Typically, the machine includes a system bus to which is attached processors, memory, e.g., random access memory (RAM), read-only memory (ROM), or other state preserving medium, storage devices, a video interface, and input/output interface ports. The machine can be controlled, at least in part, by input from conventional input devices, such as keyboards, mice, etc., as well as by directives received from another machine, interaction with a virtual reality (VR) environment, biometric feedback, or other input signal. As used herein, the term “machine” is intended to broadly encompass a single machine, or a system of communicatively coupled machines or devices operating together. Exemplary machines include computing devices such as personal computers, workstations, servers, portable computers, handheld devices, telephones, tablets, etc., as well as transportation devices, such as private or public transportation, e.g., automobiles, trains, cabs, etc.

The machine can include embedded controllers, such as programmable or non-programmable logic devices or arrays, Application Specific Integrated Circuits, embedded computers, smart cards, and the like. The machine can utilize one or more connections to one or more remote machines, such as through a network interface, modem, or other communicative coupling. Machines can be interconnected by way of a physical and/or logical network, such as an intranet, the Internet, local area networks, wide area networks, etc. One skilled in the art will appreciate that network communication can utilize various wired and/or wireless short range or long range carriers and protocols, including radio frequency (RF), satellite, microwave, Institute of Electrical and Electronics Engineers (IEEE) 545.11, Bluetooth, optical, infrared, cable, laser, etc.

The invention can be described by reference to or in conjunction with associated data including functions, procedures, data structures, application programs, instructions, etc. which, when accessed by a machine, result in the machine performing tasks or defining abstract data types or low-level hardware contexts. Associated data can be stored in, for example, the volatile and/or non-volatile memory, e.g., RAM, ROM, etc., or in other storage devices and their associated storage media, including hard-drives, floppy-disks, optical storage, tapes, flash memory, memory sticks, digital video disks, biological storage, and other tangible, physical storage media. Associated data can also be delivered over transmission environments, including the physical and/or logical network, in the form of packets, serial data, parallel data, propagated signals, etc., and can be used in a compressed or encrypted format. Associated data can be used in a distributed environment, and stored locally and/or remotely for machine access.

Having described and illustrated the principles of the invention with reference to illustrated embodiments, it will be recognized that the illustrated embodiments can be modified in arrangement and detail without departing from such principles, and can be combined in any desired manner. And although the foregoing discussion has focused on particular embodiments, other configurations are contemplated. In particular, even though expressions such as “according to an embodiment of the invention” or the like are used herein, these phrases are meant to generally reference embodiment possibilities, and are not intended to limit the invention to particular embodiment configurations. As used herein, these terms can reference the same or different embodiments that are combinable into other embodiments.

Consequently, in view of the wide variety of permutations to the embodiments described herein, this detailed description and accompanying material is intended to be illustrative only, and should not be taken as limiting the scope of the invention. What is claimed as the invention, therefore, is all such modifications as can come within the scope and spirit of the following claims and equivalents thereto.

1. An apparatus, comprising:
a card selector configured to store at least one information card;
a policy store configured to store at least one policy applicable to the information card;
a presentation modifier configured to produce a modified presentation of the information card based on the policy and rendering content; and
a presentation engine to present the modified presentation of the information card.

2. An apparatus according to claim 1, further comprising a content store to store the rendering content.

3. An apparatus according to claim 1, further comprising a cache to store the rendering content.

4. An apparatus according to claim 1, wherein the presentation modifier is operative to modify a visual presentation of said information card.

5. An apparatus according to claim 1, wherein the presentation modifier is operative to modify an aural presentation of said information card.

6. An apparatus according to claim 1, wherein the rendering content comprises at least one of a static image, an animation, and a video clip.

7. An apparatus according to claim 1, further comprising:
a transmitter configured to transmit a request for the rendering content to at least one external source; and
a receiver configured to receive the rendering content from the external source.

8. An apparatus according to claim 7, wherein the external source comprises at least one of an identity provider and a relying party.

9. An apparatus according to claim 7, wherein the at least one policy comprises an identifier of the external source for updating the rendering content.

10. An apparatus according to claim 9, wherein the at least one policy comprises a trigger for updating the rendering content from the external source.

11. An apparatus according to claim 1, wherein the card selector is further configured to define the policy based on input from a user.

12. A method for dynamic rendering of information cards, comprising:
receiving a request to access an information card from a card store;
identifying a policy applicable to a presentation of the information card;
identifying rendering content applicable to the presentation of the information card;
determining a modified presentation of the information card based on the policy and the rendering content; and
presenting the modified presentation of the information card in a card selector.

13. A method according to claim 12, wherein presenting the modified presentation of the information card in the card selector includes presenting a visual modification of the information card in the card selector.

14. A method according to claim 12, wherein presenting the modified presentation of the information card in the card selector includes presenting aural content in the card selector.

15. A method according to claim 12, wherein identifying rendering content applicable to the presentation of the information card includes accessing the rendering content from one of a local content store and a local cache.

16. A method according to claim 12, wherein identifying rendering content applicable to the presentation of the information card includes accessing the rendering content from a remote content store.

17. A method according to claim 16, wherein accessing the rendering content from a remote content store comprises querying an endpoint published at one of an identity provider and a relying party.

18. A method according to claim 16, further comprising storing the rendering content from the remote content store in a local cache.

19. A method according to claim 12, wherein presenting the modified presentation of the information card in the card selector comprises at least one of displaying the rendering content in a display area of the information card, presenting a hot spot in the display area of the information card, and displaying the rendering content in a content canvas outside of the display area of the information card.

20. An article, comprising a storage medium, said storage medium having stored thereon instructions that, when executed by a machine, result in:
receiving a request to access an information card from a card store;
identifying a policy applicable to a presentation of the information card;
identifying rendering content applicable to the presentation of the information card;
determining a modified presentation of the information card based on the policy and the rendering content; and
presenting the modified presentation of the information card in a card selector.

21. An article according to claim 20, wherein presenting the modified presentation of the information card in the card selector includes presenting a visual modification of the information card in the card selector.

22. An article according to claim 20, wherein presenting the modified presentation of the information card in the card selector includes presenting aural content in the card selector.

23. An article according to claim 20, wherein identifying rendering content applicable to the presentation of the information card includes accessing the rendering content from one of a local content store and a local cache.

24. An article according to claim 20, wherein identifying rendering content applicable to the presentation of the information card includes accessing the rendering content from a remote content store.

25. An article according to claim 24, wherein accessing the rendering content from a remote content store comprises querying an endpoint published at one of an identity provider and a relying party.

26. An article according to claim 24, said storage medium has stored thereon further instructions that, when executed by the machine, result in:
storing the rendering content from the remote content store in a local cache.

27. An article according to claim 20, wherein presenting the modified presentation of the information card in the card selector comprises at least one of displaying the rendering content in a display area of the information card, presenting a hot spot in the display area of the information card, and displaying the rendering content in a content canvas outside of the display area of the information card
